(19) United States
(12) Patent Application Publication
(10) Pub. No.: US 2018/0094936 A1
(43) Pub. Date: Apr. 5, 2018

(54) SYSTEMS AND METHODS FOR DETERMINING OR IMPROVING PRODUCT PLACEMENT AND/OR STORE LAYOUT BY ESTIMATING CUSTOMER PATHS USING LIMITED INFORMATION

(71) Applicant: Wal-Mart Stores, Inc., Bentonville, AR (US)

(72) Inventors: Nicholaus A. Jones, Fayetteville, AR (US); Steven Lewis, Bentonville, AR (US); Matthew Biermann, Fayetteville, AR (US)

(21) Appl. No.: 15/724,323

(22) Filed: Oct. 4, 2017

Related U.S. Application Data
(60) Provisional application No. 62/404,356, filed on Oct. 5, 2016.

(51) Int. Cl. G01C 21/20; G06Q 30/06; G06Q 10/04; G06Q 90/00; H04W 4/04

(52) U.S. Cl. CPC G01C 21/206; G06Q 30/0639; H04W 4/04; G06Q 90/20; G06Q 10/047

(57) ABSTRACT

Embodiments relate to systems and methods for optimizing physical layout of and product placement in a retail environment. Embodiments of systems and methods discussed herein can be used in many ways, including to analyze or determine: placement of a new product; a new location of an existing product; an improved or enhanced store layout; or an original, new store layout. Embodiments use limited information related to a customer entering a retail environment and making a purchase in the retail environment to estimate one or more possible paths taken by the customer in or through the retail environment. The estimated one or more paths then can be used to determine or adjust a physical location of at least one item in the retail environment to optimize physical layout of the retail environment.

### RELATED APPLICATION

The present application claims the benefit of U.S. Provisional Application No. 62/404,356 filed Oct. 5, 2016, which is hereby incorporated herein in its entirety by reference.

### TECHNICAL FIELD

Embodiments relate generally to retail store layouts and more particularly to determining retail store configurations and item locations from limited customer experience information.

### BACKGROUND

Retail, wholesale, membership-based, and other stores and businesses (referred to herein generally as retail stores or environments) want to arrangement their spaces in ways that enable customers to find items they seek and identify complementary and other helpful items while also making visits to stores efficient. Therefore, store layouts are planned and analyzed at many levels, from the relative arrangement of departments to the particular placement of individual products.

Store layouts and item placements are reviewed on an ongoing basis, such as to determine the placement of new products or reposition existing products that customers have been unable to find or that could benefit from a new location (e.g., arranging cross-category products adjacent one another to make item location and shopping more convenient and efficient for customers). Sometimes this involves determining and analyzing customer in-store experiences (e.g., paths taken by customers through stores), which can be a complex and data-intensive process. Additionally, some customers may not be comfortable with such a process for privacy reasons. Therefore, new ways of obtaining and analyzing customer visit and purchase information are needed.

### SUMMARY

In an embodiment, a system for optimizing physical layout of and product placement in a retail store comprises an electronic customer identification module configured to be arranged in a retail store to identify a customer proximate an entrance into the retail store, the identified entrance defining a first customer path data point comprising a first time stamp; a point-of-sale (POS) system in the retail store configured to identify a purchase of at least one item by the customer in the retail store, the identified purchase defining a second customer path data point comprising a second time stamp, and the at least one item defining, respectively, at least one intermediary customer path data point; and a customer path estimation engine communicatively coupled with the customer identification module and the POS system and configured to use the first customer path data point, the second customer path data point, and the at least one intermediary customer path data point to construct at least one time-possible path the customer took between the customer identification module and the POS system, and to use the at least one time-possible path of a plurality of customers to suggest at least one of a change of physical location of at least one item in the retail store, a physical placement of a new item in retail store, or a physical layout of a retail store, to optimize product placement in the retail store.

In an embodiment, a method for optimizing physical layout of and product placement in a retail store comprises electronically identifying an entrance of a customer into a retail store, the identified entrance defining a first customer path data point comprising a first time stamp; electronically identifying a purchase of at least one item by the customer in the retail store, the identified purchase defining a second customer path data point comprising a second time stamp, and the at least one item defining, respectively, at least one intermediary customer path data point; constructing at least one time-possible path the customer took in the store between the detected entrance and the detected purchase; and suggesting at least one of a change of physical location of at least one item in the retail store, a physical placement of a new item in retail store, or a physical layout of a retail store, to optimize product placement in the retail store, using the at least one constructed time-possible path.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for optimizing physical layout of and product placement in a retail environment according to an embodiment.

FIG. 2 is a block diagram of a customer path in a retail environment according to an embodiment.

FIG. 3 is a block diagram of inputs to a customer path estimation engine according to an embodiment.

FIG. 4A is a first possible constructed customer path in a retail environment according to an embodiment.

FIG. 4B is a second possible constructed customer path in a retail environment according to an embodiment.

FIG. 4C is a second possible constructed customer path in a retail environment according to an embodiment.

FIG. 5 is a flowchart of a method of optimizing physical layout of and product placement in a retail environment according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments relate to systems and methods for optimizing physical layout of and product placement in a retail environment. Embodiments of systems and methods discussed herein can be used in many ways, including to analyze or determine: placement of a new product; a new location of an existing product; an improved or enhanced store layout; or an original, new store layout. Embodiments use limited information related to a customer entering a retail environment and making a purchase in the retail environment to estimate one or more possible paths taken by the customer in or through the retail environment. The estimated one or more paths then can be used to determine or adjust a physical location of at least one item in the retail environment to optimize physical layout of the retail environment.

The retail stores or environments in which these systems and methods can be used can be virtually any retail outlet, including a physical, brick-and-mortar storefront; an internet-based outlet; a hybrid of the two; or some other setting or location via which a customer may purchase or obtain products. In some embodiments, the retail environment is a wholesale club or other membership-based retail environment for which customer-members have membership cards or other required identifying information. Though only a single retail environment may be discussed in examples used herein, in many cases the systems and methods can include a plurality of retail environments. For example, data from one or a plurality of retail environments can be aggregated and analyzed and applied to one or a plurality of other retail environments.

The retail environment can be associated with a retailer, such as by being a subsidiary, franchise, owned outlet, or other affiliate of the retailer. The retailer can be or have a home office or headquarters of a company, or some other affiliate, which often is located apart from the retail environment itself. In some embodiments, facilities or functions associated with the broader retailer can be partially or fully co-located with the retail environment. For example, the retailer can host some or all of an internet-based website retail environment. In another example, the retailer and a brick-and-mortar retail environment can be co-located.

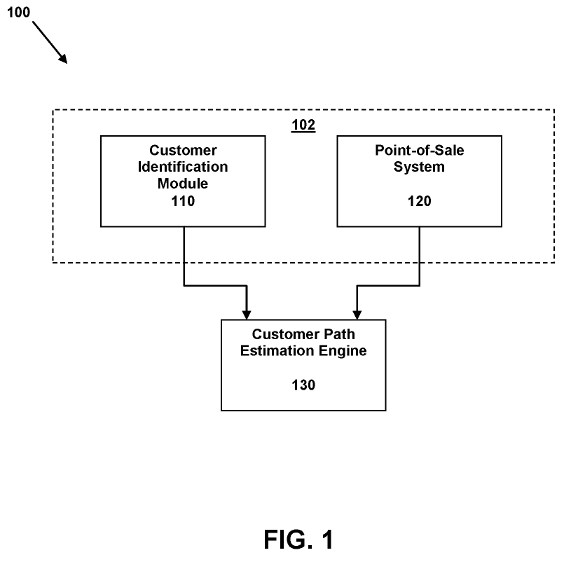

Referring to FIG. 1, an embodiment of a system 100 for optimizing physical layout of and product placement in a retail store is depicted. As depicted, system 100 comprises a customer identification module 110, a point-of-sale system 120 and a customer path estimation engine 130. In embodiments, customer identification module 110 and point-of-sale system 120 are co-located in a retail environment 102.

Customer identification module 110 generally comprises a kiosk, stand or other physical unit or device that includes or supports one or more electronic elements or devices via which a customer or customer-member can be identified. In some embodiments, customers can be customer-members, with membership cards or other credentials to identify their membership status. In other embodiments in non-membership retail environments, customers can have loyalty cards or other credentials that identify the customer to the retailer. Thus, the customer or customer-member (generally herein simply “customer”) is identified electronically, such as via a membership card, a credit or debit card, a chip-and-pin card, a card comprising a radio frequency identification (RFID) chip, an identification card, an electronic card displayed on a cell phone or other mobile electronic device, or some other card. In other embodiments, electronic identification of the customer can be done using biometric information, which can include fingerprints, voice recognition, facial recognition or other biometric information. In still other embodiments, electronic identification of the customer can include a customer log-in using a username and password or other identification. Thus, in various embodiments, customer identification module 110 comprises at least one of a magnetic stripe reader, a bar code reader, a contactless electronic payment terminal, a chip-and-pin reader, a biometric identification system, a scanner, a mouse, a camera, a voice recognition system, a radio frequency identification (RFID) system, a BLUETOOTH system, a WIFI system, a near-field communication (NFC) antenna, or a keyboard. Customer identification module 110, in any embodiment, also can comprise display capabilities configured to display prompts, information or other interfaces to the customer or another user (e.g., retailer personnel) to determine the customer's identity.

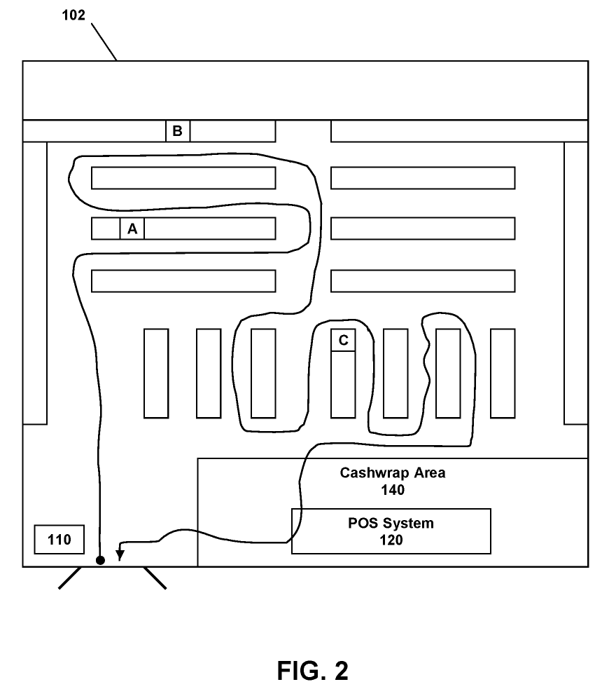

In embodiments, and referring also to FIG. 2, customer identification module 110 is arranged at or proximate to an entrance to retailer 102 to electronically identify a customer's presence in retailer 140 as the customer enters retailer 102, either automatically (e.g., via one of the wireless technologies discussed above) or manually (e.g., via customers swiping or scanning their membership card or otherwise interacting with customer identification module 110). In other embodiments, customer identification module 110 is arranged or otherwise configured to detect or determine a customer's presence in or at another location in retailer 102.

Still other ways of identifying customers can be used. For example, retailer personnel can operate handheld scanners, readers or other devices, including those that comprise one or more of the technologies identified above. In another example, electronic identification of the customer can be accomplished by detecting a mobile device (e.g., smartphone, tablet, wearable electronic device) within a geofence associated with retailer 102. Those of ordinary skill in the art will appreciate that other ways of identifying a customer's entrance into or presence at a retailer also can be used.

When a customer checks in or otherwise interacts with customer identification module 110, customer identification module 110 identifies the customer and records a corresponding time stamp. In some embodiments, customer identification module 110 can comprise memory and a database in which to store the customer and time stamp information. In other embodiments, this information is communicated by customer identification module 110 to customer path estimation engine 130. This communication can be wireless, wired, or transferred in another way (e.g., by an employee of retailer 102 downloading batch data from module 110 periodically and transferring the data in some way to customer path estimation engine).

After checking in via customer identification module 110, the customer takes some path in retailer 102 as they do their shopping. An example path is shown in solid line in FIG. 2, via which the customer collects items from locations A, B and C. The customer then takes the assembled items to cashwrap area 140 to make a purchase via point-of-sale system 120.

Point-of-sale (POS) system 120 can comprise or be communicatively coupled with the cash register computer system in retailer 102 (and/or an online payment system for retailers having web-based stores) in order to provide information about purchases made by customers in or from retailer 102. In membership-based retail or other business, customers typically must provide a membership card or other identification information at the time of making purchases, similar to as discussed above to identify the customer-members by or at customer identification module 110. This can enable system 100 to link information about customer visits to or presence at retailer 102 with purchases made at or from retailer 102, including purchases made during particular visits. Additionally, customer check-out via POS system 120 can provide a timestamp associated with customer presence at POS system 120 so that system 100 can determine an approximate length of customer visit to retailer 102 from the first timestamp at customer identification module 110 and the second timestamp at POS system 120. In still other embodiments, customer identification module 110 can comprise an additional unit at POS system 120 or proximate an exit of retailer 102 to determine when a customer is leaving retailer 102. This can be helpful when customers do not make purchases and so do not interact with POS system 120.

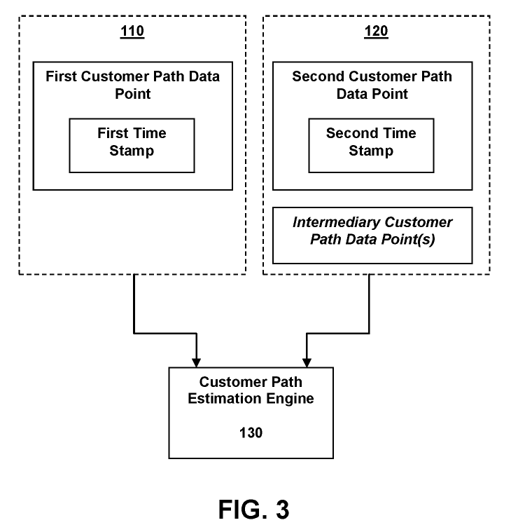

Referring also to FIG. 3, once a customer has completed a visit to retailer 102, including interacting with customer identification module 110 and POS system 120, several data elements have been collected by system 100: a first customer path data point comprising a first time stamp from customer identification module 110, and a second customer path data point comprising a second time stamp from POS system 120. If the customer made a purchase at POS system 120, each item purchased defines an intermediary customer path data point. In other words, system 100 knows where the customer was a first time (customer identification module 110) and a second time (POS system 120), and locations in retailer 102 where the customer was between the first and second times, based on items purchased by the customer and knowledge system 100 has about where each item is located in retailer 102. In the context of the example of FIG. 2, system 100 knows when the customer was at each of customer identification module 110 and cashwrap area 140 (via interaction with POS system 120), and that the customer was at locations A, B and C at times in between being at customer identification module 110 and cashwrap area 140.

These data elements are communicated to or otherwise assembled by customer path estimation engine 130, which is communicatively coupled with customer identification module 110 and POS system 120 in embodiments. In some embodiments, customer path estimation engine 130 is located remote from retailer 102 (e.g., at a home office) and can be communicatively coupled with multiple locations of retailer 102. In other embodiments, customer path estimation engine 130 is co-located, at least in part, at retailer 102. In still other embodiments, some or all of customer identification module 110, POS system 120 and customer path estimation engine 130 are coupled with or form part of a cloud-based computing environment. A cloud-based computing environment can comprise one in which data is stored on one or more physical servers that can be located in one or more locations. The one or more locations typically, but not necessarily, are remote from the data sources (e.g., system 100 and/or retailer 102). The servers and other hardware and software associated with the cloud-based system can be owned by retailer 102 or by an external company, such as a hosting company, from which retailer 102 buys or rents storage space. In embodiment, the cloud-based or some other suitable storage system comprising a database can store information related to purchased items, purchased item locations, and customer interaction points and timestamps. This information can be concatenated in a database entry, stored together in logical pools, or arranged in the database in some other suitable form.

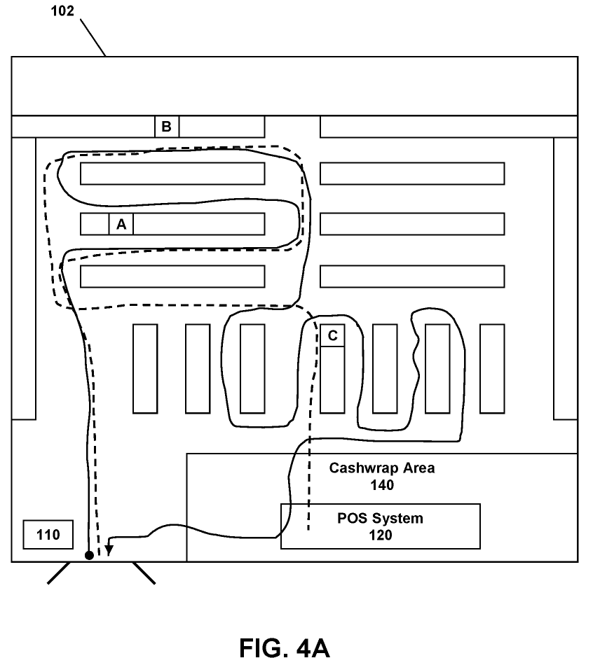

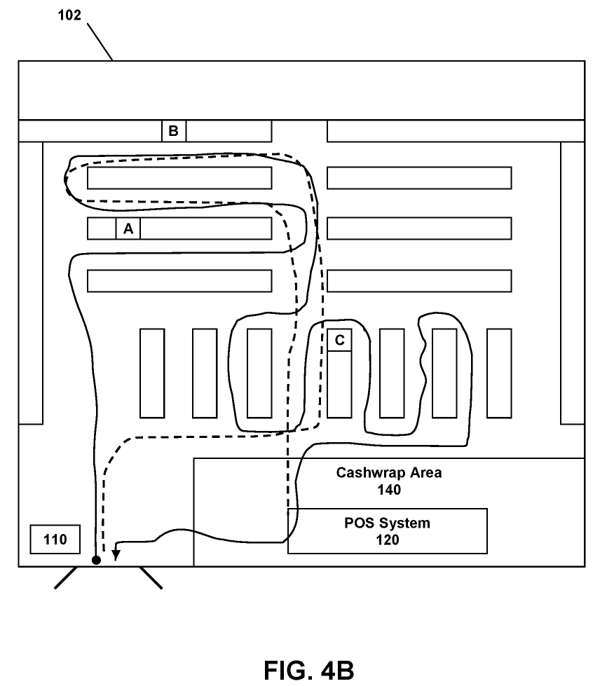

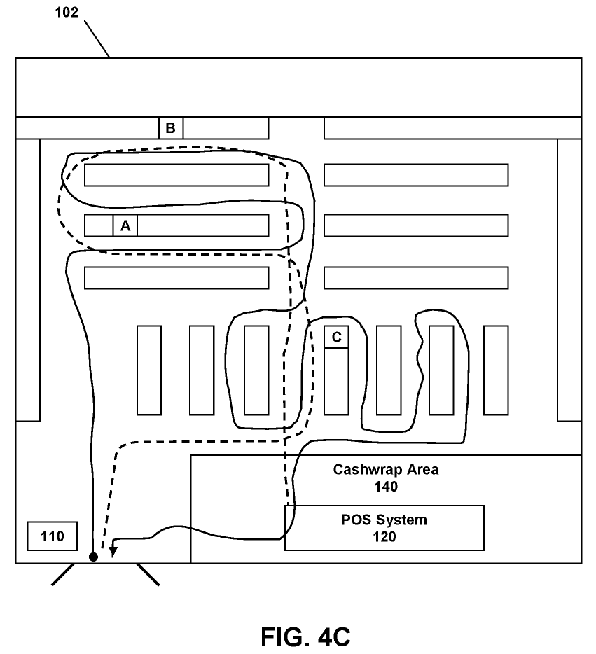

Customer path estimation engine 130 is configured to use the first customer path data point, the second customer path data point, and the at least one intermediary customer path data point to construct at least one time-possible path the customer took between customer identification module 110 and POS system 120. A first possible customer path is shown in dashed line in FIG. 4A, a second possible customer path is shown in dashed line in FIG. 4B, and a third possible customer path is shown in dashed line in FIG. 4C. None of the paths are exactly the same as the actual path taken by the customer, but from minimal information customer path estimation engine 130 is able to construct one or a plurality of possible paths taken by a customer through retailer 102.

In one embodiment, customer path estimation engine 130 can comprise and use a generic speed at which a typical customer would travel through the store in estimated customer path construction. In some circumstances, this generic speed can be enhanced by knowing the type of customer (including if the customer is shopping alone or with others, as this can affect shopping time and may be determined, at least in part, by the types of items purchased) or previous data related to a particular customer. In general, however, customer path estimation engine can use the generic or enhanced speed plus some amount of dwell time to determine how much of retailer 102 the customer could cover. In some embodiments, dwell time can relate, at least in part, to items stocking levels at the time, such that this factor also can be considered by customer path estimation engine 130. In situations in which items are displayed in multiple locations in retailer 102 (e.g., chocolate sauce is shelved in the condiments isle and also located on a special summer season endcap near the ice cream in frozen foods), customer path estimation engine 130 can determine which location may have been visited from other information available (e.g., the customer also purchased ice cream immediately adjacent the aforementioned endcap) or may construct multiple possible paths, as is discussed below.

Customer path estimation engine 130 also can consider the particular layout of retailer 102, including shelf placement and other fixtures or obstacles that the customer necessarily must navigate (i.e., customer path estimation engine 130 cannot construct a path that would require a customer to traverse a shelf rather than walk around it). Additionally, customer path estimation engine 130 can consider space loading (e.g., how many other customers are present in the store), including how some possible customer paths could impact other possible customer paths occurring at the same time.

Thus, the paths are time-possible based on one or more criteria, such that they are humanly possible to achieve, fit general human/customer behaviors, include visits to each location from which items were selected, and consider other factors and information available to customer path estimation engine 130.

In some embodiments, customer path estimation engine 130 is configured to construct only a single, most-likely path. Whether a path is most likely can be determined by customer path estimation engine 130 based on the amount of time between the first and second time stamps, additional customer identification opportunities (e.g., a customer may interact with other customer identification modules 110 or personnel throughout retailer 102, such as in an electronics department, a pharmacy, a product demonstration area, a special display, a coupon or discount dispenser, etc.), other data available to customer path estimation engine 130 based on previous visits to and purchases at retailer 102 by the same customer or other customers, known item information known event information (e.g., product demonstrations being conducted near item B that may have caused the customer to pause during their visit), known customer behavior information (e.g., item B is a frozen item, and customer path estimation engine 130 has data that customers tend to select frozen items last so that they do not thaw or melt while the customer is in the store), known department information (e.g., the customer picked up a prescription during their visit, and customer path estimation engine 130 has data that customers spend approximately n minutes interacting with pharmacy staff), known customer information (e.g., a particular customer often purchases children's toys, and on a visit during which the customer did not purchase a toy but had a longer visit not easily explained by the items purchased, customer path estimation engine may assume the customer visited the toy department to browse but did not make a purchase on this particular visit) and/or other information about retailer 102 or the customer.

In other embodiments, customer path estimation engine 130 is configured to construct a plurality of possible paths taken by the customer (as can be seen by FIGS. 4A-4C). In some embodiments, multiple paths can be helpful, individually or in aggregate, for analysis. In other embodiments, customer path estimation engine 130 can construct multiple paths and analyze the multiple paths to determine a most likely path. For example, if a high number of possible paths show the same partial path, customer path estimation engine 130 can select that partial path as highly likely to have been taken and then build the rest of the path around it.

In embodiments, the one or plurality of possible paths constructed by customer path estimation engine 130 can be used to suggest a change of physical location of at least one item in the retail store to optimize physical layout of retailer 102, determine a location of a new item to be added to retailer 102, determine a layout of a new retailer 102, and/or to make another determination or change related to retailer 102. These suggestions can be provided in a variety of ways. For example, system 100 can generate an instruction to an associate at retailer 102 to add one item to another item's location. This instruction can be provided electronically, such as via a computer or other electronic device used by the associate in his or her day-to-day work. This instruction also can be provided manually, such as in a report or diagram related to a portion of retailer 102. In another example, system 100 can provide an updated or new design for a particular shelf of modular, which could also be provided to an associate electronically or manually at retailer 102. In a particular example, system 100 can generate a visual of a particular modular with images of products and placement for an associate to replicate in retailer 102. The suggestions made by customer path estimation engine 130 can be permanent or temporary. For example, customer path estimation engine 130 can suggest locating a special product display in a particular area between 3-7 pm because customer paths often pass that area, and customers may be seeking ideas for preparing an evening meal. The suggestions of customer path estimation engine 130 can be applied to the same retailer 102 in which the customer paths were estimated or other retailers. For example, two locations of retailer 102 may share similar customer demographic or other characteristics, such that data from the first location, either originally or after showing success, can be applied at the second location. The same is true for a new location to be opened, with data relating to item location or layout from an existing location used to determine item location or layout of the new location.

Customer path estimation engine 130 also can aggregate data for a particular customer or pluralities of customers. For example, customer path estimation engine 130 can determine that one customer frequently buys the same items on different visits. If that customer purchases a new item on one visit and the visit time is significantly longer than is usual for that customer, customer path estimation engine 130 may determine that the customer had difficulty locating the new item because it is not in a convenient or intuitive location. Relocation of that item could be suggested. In another example, customer path estimation engine can compare data for two customers who shop at two different retailers 102 but purchase similar items. The data of one customer may show that that customer's location has a preferred layout, which can be determined by correlating the data between the customers, creating path maps from the individual data points, and comparing the maps to compare conditions, arrangements and other factors between the two locations.

In embodiments, customer path estimation engine 130 can make specific suggestions based on the data and analysis. In other embodiments, customer path estimation engine 130 can additionally consider manual input from an analyst user. In these embodiments, system 100 can further comprise a user interface (not depicted) communicatively coupled with customer path estimation engine 130. Via this user interface, a user can input additional data, criteria, or other information, and receive and interact with analysis, maps, data and other information from customer path estimation engine 130 and system 100 as a whole.

In general, however, the amount and type of data managed, processed and analyzed by customer path estimation engine 130 and system 100 is outside the capabilities of manual processing and beyond mere automation of tasks that have been or could be performed by hand. In particular, system 100 can access huge volumes of data, relating to thousands or millions of customers/customer visits and hundreds or thousands of retailers. This data can relate to data collected over time (e.g., weeks, months or even years) for millions of items and locations. The hardware and software components of system 100 can analyze, correlate and transform this data into the meaningful result of a physical change of an item location or retailer layout, among other things.

Going forward, data related to relocated items, newly located items or new layouts of retailer 102 can be analyzed for continuous improvement on-site or application of the same or similar changes at other locations of retailer 102. In some embodiments, customer path estimation engine 130 can provide suggestions for temporary (e.g., seasonal) item locations based on data from particular time periods or seasons in past years. More generally, customer path estimation engine 130 and system 100 can be used to proactively locate and even relocate items and groups of items to improve customer experience, retailer sales, and other real-world benefits.

These and other advantages can be achieved at lower cost and complexity than conventional systems can track customer paths, as well as with improved customer comfort as customers are not physically tracked in stores, which can make some uncomfortable or even opt out of participation. Additionally, some conventional systems rely on using customer devices (e.g., smartphones, tablets) or expensive technology infrastructure, which are not necessary here.

Yet another advantage can be integration of system 100 with employee incentive and other programs. For example, an additional customer identification module 110 can be located at a product demonstration station a product demonstration location, a product sampling location, an item display location, an in-store amenity location, a staffed location, or a service location so that customers can or must check in before interacting with these locations. For example, if the location is a product demonstration or sampling location, the customer must check in at the additional customer identification module 110 before receiving a sample. Data from this module (including a time stamp of the customer check-in) can be included or correlated with customer path and purchase information to determine the effectiveness of the demonstration, its personnel, the item, and its location. This, in turn, can be used to provide rewards to product demonstration personnel when customer purchase the demonstrated items or to determine where, when and/or which items to demonstrate in the future. Demonstrated item purchase data can be correlated with other customer purchases to identify complementary or other items, which then can be used for location and other analytics.

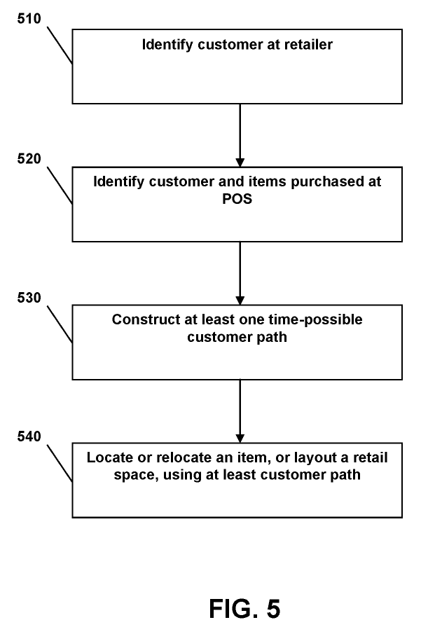

Referring to FIG. 5, a flowchart of one embodiment of a method related to system 100 is depicted. At 510, a customer enters a retailer 102 and is identified at customer identification module 110, such as via membership card or other credentials or information. A time stamp of this identification is noted. At 520, the customer is identified at POS system 120, along with items purchased by the customer. A time stamp of this customer interaction is noted. At least one possible path taken by the customer in retailer 102 is then constructed from the presence and time of the customer at customer identification module 110, and the presence, time and purchases by the customer at POS system 120, at 530. Optionally, additional data points (and time stamps, if they are available) associated with the customer or items purchased can be used, such as if the customer checked in at a product demonstration area or other in-retailer location. At 540, the at least one time-possible customer path can be used to locate or relocate an item in retailer 102 or to arrange a new location of retailer 102.

In embodiments, system 100 and/or its components or systems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for optimizing physical layout of and product placement in a retail store comprising:
an electronic customer identification module configured to be arranged in a retail store to identify a customer proximate an entrance into the retail store, the identified entrance defining a first customer path data point comprising a first time stamp;
a point-of-sale (POS) system in the retail store configured to identify a purchase of at least one item by the customer in the retail store, the identified purchase defining a second customer path data point comprising a second time stamp, and the at least one item defining, respectively, at least one intermediary customer path data point; and
a customer path estimation engine communicatively coupled with the customer identification module and the POS system and configured to use the first customer path data point, the second customer path data point, and the at least one intermediary customer path data point to construct at least one time-possible path the customer took between the customer identification module and the POS system, and to use the at least one time-possible path of a plurality of customers to suggest at least one of a change of physical location of at least one item in the retail store, a physical placement of a new item in retail store, or a physical layout of a retail store, to optimize product placement in the retail store.

2. The system of claim 1, wherein the customer is a member of the retail store, and the customer identification module is configured to identify the entrance of the customer into the retail store by membership information of the customer.

3. The system of claim 2, wherein the membership information comprises a membership card.

4. The system of claim 3, wherein the membership card is a physical card, and wherein the customer identification module comprises at least one of a magnetic stripe reader, a bar code reader, a Q-code reader, a contactless electronic payment terminal, a chip-and-pin reader, a scanner, a mouse, a camera, a radio frequency identification (RFID) system, a near-field communication (NFC) antenna, or a keyboard.

5. The system of claim 3, wherein the membership card is electronic, and wherein the customer identification module comprises at least one of a magnetic stripe reader, a bar code reader, a Q-code reader, a contactless electronic payment terminal, a chip-and-pin reader, a scanner, a mouse, a camera, a radio frequency identification (RFID) system, a near-field communication (NFC) antenna, a keyboard, a biometric identification system, a voice recognition system, or a BLUETOOTH system.

6. The system of claim 5, wherein the electronic membership card is displayable on a portable electronic device.

7. The system of claim 6, wherein the portable electronic device comprises at least one of a mobile phone, a tablet computing device, a smart watch, or a wearable smart device.

8. The system of claim 2, wherein the POS system is configured to detect the purchase by the customer by the membership information of the customer.

9. The system of claim 1, further comprising at least one additional electronic detection module configured to be arranged in the retail store to detect a presence of the customer at a location of the at least one additional electronic customer detection module in the retail store, the detected presence defining an additional customer path data point comprising a third time stamp, wherein the customer path estimation engine is communicatively coupled with the additional electronic customer detection module and configured to use the additional customer path data point to construct the at least one time-possible path the customer took between the electronic customer detection module, the additional electronic customer detection module and the POS system.

10. The system of claim 9, wherein the location of the at least one additional customer identification module is at least one of a product demonstration location, a product sampling location, an item display location, an in-store amenity location, a staffed location, or a service location.

11. The system of claim 10, wherein the customer path estimation engine is configured to correlate data from the at least one additional electronic customer identification module with purchase data from the POS and use the correlated data to suggest a change of physical location of at least one item in the retail store to optimize physical layout of the store.

12. The system of claim 1, wherein the customer path estimation engine is communicatively coupled with customer identification modules and POS systems in a plurality of retail stores and configured to use constructed time-possible paths of a plurality of customers in a plurality of retail stores to suggest a change of physical location of at least one item in at least one of the plurality of retail stores to optimize physical layout of the retail store.

13. A method for optimizing physical layout of and product placement in a retail store comprising:
electronically identifying an entrance of a customer into a retail store, the identified entrance defining a first customer path data point comprising a first time stamp;
electronically identifying a purchase of at least one item by the customer in the retail store, the identified purchase defining a second customer path data point comprising a second time stamp, and the at least one item defining, respectively, at least one intermediary customer path data point;
constructing at least one time-possible path the customer took in the store between the detected entrance and the detected purchase; and
suggesting at least one of a change of physical location of at least one item in the retail store, a physical placement of a new item in retail store, or a physical layout of a retail store, to optimize product placement in the retail store, using the at least one constructed time-possible path.

14. The method of claim 13, wherein the customer is a member of the retail store, and wherein the method further comprises identifying the entrance of the customer into the retail store by membership information of the customer.

15. The method of claim 14, wherein identifying the entrance of the customer into the retail store further comprises obtaining the membership information by at least one of a magnetic stripe reader, a bar code reader, a Q-code reader, a contactless electronic payment terminal, a chip-and-pin reader, a scanner, a mouse, a camera, a radio frequency identification (RFID) system, a near-field communication (NFC) antenna, a keyboard, a biometric identification system, a voice recognition system, or a BLUETOOTH system.

16. The method of claim 15, wherein obtaining the membership information further comprises displaying an electronic membership card a portable electronic device.

17. The method of claim 16, wherein the portable electronic device comprises at least one of a mobile phone, a tablet computing device, a smart watch, or a wearable smart device.

18. The method of claim 14, further comprising identifying the purchase by the customer by the membership information of the customer.

19. The method of claim 13, further comprising:
arranging at least one additional electronic customer detection module in the retail store; and
identifying a presence of the customer at a location of the at least one additional electronic customer detection module in the retail store, the identified presence defining an additional customer path data point comprising a third time stamp,
wherein the suggesting further comprises using the additional customer path data point to construct the at least one time-possible path the customer took between the electronic customer detection module, the additional electronic customer detection module and the POS system.

20. The method of claim 19, wherein the arranging further comprises arranging the at least one additional electronic customer detection module at at least one of a product demonstration location, a product sampling location, an item display location, an in-store amenity location, a staffed location, or a service location.

21. The method of claim 20, wherein the suggesting further comprises correlating data from the at least one additional electronic customer detection module with purchase data from the POS, and using the correlated data to suggest a change of physical location of at least one item in the retail store to optimize physical layout of the store.

22. The method of claim 13, further comprising using constructed time-possible paths of a plurality of customers in a plurality of retail stores to suggest a change of physical location of at least one item in at least one of the plurality of retail stores to optimize physical layout of the retail store.
